(19) United States
(12) Patent Application Publication
(10) Pub. No.: US 2025/0392394 A1
(43) Pub. Date: Dec. 25, 2025

(54) TRANSMITTER-RECEIVER INTERMEDIATE FREQUENCY (IF)-ASSISTED DECOMPOSITION OF SYSTEM TRANSFER FUNCTION

(71) Applicant: CIENA CORPORATION, Hanover, MD (US)

(72) Inventors: Shahab Oveis Gharan, Ottawa (CA); Andrzej Borowiec, Ottawa (CA)

(73) Assignee: CIENA CORPORATION, Hanover, MD (US)

(21) Appl. No.: 18/753,297

(22) Filed: Jun. 25, 2024

(51) Int. Cl. H04B 10/61; H04B 10/50

(52) U.S. Cl. CPC H04B 10/6164; H04B 10/503; H04B 10/6165

(57) ABSTRACT

Aspects of the subject disclosure may include, for example, based on a transmission of a transmit (Tx) signal from a coherent optical transmitter to a coherent optical receiver, extracting a transfer function of the coherent optical transmitter, a transfer function of the coherent optical receiver, one or more impairments associated with the coherent optical transmitter, one or more impairments associated with the coherent optical receiver, or a combination thereof to facilitate calibration or impairment characterization of one or more of the coherent optical transmitter and the coherent optical receiver, wherein an offset between a laser frequency of the coherent optical transmitter and a laser frequency of the coherent optical receiver satisfies a threshold so as to enable the extracting. Other embodiments are disclosed.

### FIELD OF THE DISCLOSURE

The subject disclosure relates to methods and systems for transmitter-receiver intermediate frequency (IF)-assisted decomposition of system transfer function(s).

### BACKGROUND

Calibration of the analog/optical (electro-optic (EO)/opto-electrical (OE)) chains of a transmitter (Tx) and receiver (Rx) is a critical part of optical modem manufacturing. Many modems feature transmitter front end test (TFET) and receiver front end test (RFET) memory banks that allow for uploading/downloading of test patterns to the modem for use in calibrating components in the EO/OE chains. These components include digital-to-analog converters (DACs), radio frequency (RF) drivers, modulators, receiver optics, amplifiers, and analog-to-digital converters (ADCs).

### BRIEF DESCRIPTION OF THE DRAWINGS

Reference will now be made to the accompanying drawings, which are not necessarily drawn to scale, and wherein:

FIG. 1 is a diagram of a non-limiting example of a communication network in accordance with various aspects described herein.

FIG. 2A is a block diagram of an example, non-limiting embodiment of a transmitter/modulator system in accordance with various aspects described herein.

FIG. 2B is a block diagram of an example, non-limiting embodiment of a receiver device in accordance with various aspects described herein.

FIG. 2C illustrates several example implementation scenarios involving a transmitter-receiver intermediate frequency (IF)-assisted decomposition (TRIAD) algorithm in accordance with various aspects described herein.

FIGS. 2D to 2V show example simulation and experimental results relating to use of the TRIAD algorithm.

FIG. 3 depicts an illustrative embodiment of a method in accordance with various aspects described herein.

FIG. 4 is a block diagram of an example, non-limiting embodiment of a computing environment in accordance with various aspects described herein.

### DETAILED DESCRIPTION

One method of Tx calibration requires the use of an external optical detector and a digital sampling oscilloscope (DCO), where the transfer function of the Tx is measured by uploading a known waveform to the TFET memory, and capturing optical waveforms with the DCO, one tributary (e.g., X polarization In-phase (XI), X polarization Quadrature-phase (XQ), Y polarization In-phase (YI), and Y polarization Quadrature-phase (YQ)) at a time. After capturing all tributaries, the transfer function of each tributary is then extracted using the least-mean-square (LMS) algorithm. This method has a number of shortcomings. First, during the calibration process, the Tx optics are generally biased in a different mode (i.e., in a quadrature or Quad mode) than when the modem is used in normal operations (i.e., a minimum or Min mode). The underlying conditions for Tx measurement are thus different from those during normal usage conditions. Further, the method does not provide any crosstalk information between different Tx tributaries (such as crosstalk between XI and XQ tributaries) or Tx EO nonlinear information (such as nonlinearities associated with the Tx driver and/or Tx modulator).

One method of Rx calibration relies on the availability/presumption of a perfectly calibrated Tx. This Rx calibration process consists of two steps. In the first step, an amplified spontaneous emission (ASE) signal is captured and downloaded from the RFET memory to measure the amplitude-only response of the Rx transfer function. The second calibration step consists of a phase-only measurement, which involves the uploading of a known pattern to a single Tx tributary (e.g., XI), resulting in a single polarization output. A polarization locker is then used to align the optical input to the Rx at 45 degrees relative to the Rx axis. During this process, data from the RFET memory is repeatedly downloaded and used to extract the phase response. The following are various shortcomings of this Rx calibration method:
high costs associated with the necessary test stations;
increased hardware complexity (e.g., the polarization locker);
slow calibration speed/factory throughput;
Rx calibration not being performed in conditions like those during nominal modem operation;
inability to distinguish and exclude residual Tx impairments during Rx calibration;
inability to extract residual time delays;
inability to extract crosstalk terms between different Rx tributaries;
inability to extract nonlinear terms of Tx/Rx EO/OE chains; and
inability to implement the entire Rx acquisition or in-service calibration algorithm in the modem firmware.

The subject disclosure describes, among other things, illustrative embodiments of a transmitter-receiver IF-assisted decomposition (TRIAD) method and system that is capable of facilitating (e.g., with a single measurement) Tx/Rx analog chain calibration/impairment characterization in a factory or lab setting and/or Tx/Rx analog chain impairment characterization in a mission mode (i.e., during nominal operating conditions). Tx/Rx calibration may, for instance, involve the preparation of a periodic test waveform with uniform spectral content up to a desired bandwidth, optionally using a free-running counter to synchronize the TFET-RFET memories to increase (e.g., maximize) the number of samples used in the algorithm's calculations, and the processing of the reference and RFET waveforms with the TRIAD algorithm (details described below).

In exemplary embodiments, the TRIAD algorithm may be implemented for the Tx and Rx of a single coherent optical modem for calibration/impairment characterization purposes during modem manufacturing/testing. In these embodiments, an acousto-optical modulator (AOM) may be employed between the output of the Tx and the input of the Rx to provide an IF. A large enough IF is critical for successful measurement of Tx and Rx mismatches/nonidealities, since a large IF mixes up transmit I/Q tributaries that are later detected by Rx PIN diodes. If there is otherwise little to no laser IF, Tx and Rx I/Q impairments, such as differential mismatches and I/Q crosstalk (XTalk), would be mixed up between the Tx and Rx, and the receiver would be unable to separate Tx impairments from Rx impairments. Use of the AOM in various embodiments allows for a frequency offset to be imparted onto the transmit waveform, resulting in an IF that “breaks the symmetry” between the Tx and the Rx.

In certain embodiments, the TRIAD algorithm may be implemented for two different (or independent) modems, where the IF is a result of (e.g., a large enough) frequency offset between lasers of the two modems. While this might be less desirable in a factory setting due to higher test station costs, it would nevertheless be useful for facilitating the design and/or testing of optical Rx component(s), the design and/or testing of lab instrument(s), or the calibration/impairment characterization of an “unknown” Rx of one modem using a reference (or “golden”) Tx of another modem. In some embodiments, the TRIAD algorithm may be employed during nominal operating conditions of a given optical modem to facilitate impairment characterizations of Tx/Rx (e.g., in real-time or near real-time).

Exemplary embodiments of the technique described herein enable Tx and Rx calibration using a (e.g., single) measurement test bed. In the case of a pre-calibrated transmitter, the technique provides substantial measurement speed improvements in Rx calibration (e.g., for the Rx transfer function) as compared to methods typically employed today. The exemplary method advantageously provides the means for measuring the Tx/Rx transfer function(s) in mission mode, measuring the crosstalk transfer function(s) of the Tx/Rx, measuring Tx/Rx nonlinearities (including the calibration of Tx/Rx nonlinear correction circuit(s) either in factory calibration or in mission mode), and measuring and calibrating Tx/Rx crosstalk (including the calibration of Tx/Rx crosstalk correction circuit(s) either in factory calibration or in mission mode). Both the homodyne approach (where the same laser is used for the Tx and the Rx) and the heterodyne approach (where different lasers are used for the Tx and the Rx) enable extraction of the Tx/Rx transfer function(s) and Tx/Rx impairment(s), such as crosstalk terms, nonlinearities, residual delays, and quadrature errors (QEs). The use of an AOM in the homodyne approach for adding IF also diminishes the effects of clock jitter between the reference Tx and Rx under test, and eliminates a need to rely on a “golden” transmitter, which reduces the cost and complexity of the calibration work station. One skilled in the art would readily recognize the improved modem manufacturing and calibration speed that can be achieved with the exemplary technique. It is to be understood and appreciated that the TRIAD procedure is not limited to modem characterization. For instance, the algorithm can additionally, or alternatively, be used to characterize any optical system that can produce repeated optical test signals, such as research grade test/prototype setups, optical capture-and-compute setups, optical modulation analyzers, or other optical receivers. Further, the TRIAD algorithm can be implemented partially or entirely in modem firmware, which further simplifies and reduces the cost of calibration.

One or more aspects of the subject disclosure include a device, comprising a processing system including a processor, and a memory that stores executable instructions that, when executed by the processing system, facilitate performance of operations. The operations can include based on a transmission of a transmit (Tx) pattern from a coherent optical transmitter and a receipt of a corresponding receive (Rx) pattern at a coherent optical receiver, extracting a transfer function of the coherent optical transmitter, a transfer function of the coherent optical receiver, one or more impairments associated with the coherent optical transmitter, one or more impairments associated with the coherent optical receiver, or a combination thereof to facilitate calibration or impairment characterization of one or more of the coherent optical transmitter and the coherent optical receiver, wherein an offset between a laser frequency of the coherent optical transmitter and a laser frequency of the coherent optical receiver satisfies a threshold so as to enable the extracting.

One or more aspects of the subject disclosure include a non-transitory machine-readable medium, comprising executable instructions that, when executed by a processing system including a processor, facilitate performance of operations. The operations can include based on a transmission of a transmit (Tx) pattern from a coherent optical transmitter and a receipt of a corresponding receive (Rx) pattern at a coherent optical receiver, extracting a transfer function of the coherent optical transmitter, a transfer function of the coherent optical receiver, one or more impairments associated with the coherent optical transmitter, one or more impairments associated with the coherent optical receiver, or a combination thereof to facilitate calibration or impairment characterization of one or more of the coherent optical transmitter and the coherent optical receiver, wherein an offset between a laser frequency of the coherent optical transmitter and a laser frequency of the coherent optical receiver satisfies a threshold so as to enable the extracting.

One or more aspects of the subject disclosure include a method. The method can comprise based on a transmission of a transmit (Tx) pattern from a coherent optical transmitter and a receipt of a corresponding receive (Rx) pattern at a coherent optical receiver, extracting, by a processing system including a processor, a transfer function of the coherent optical transmitter, a transfer function of the coherent optical receiver, one or more impairments associated with the coherent optical transmitter, one or more impairments associated with the coherent optical receiver, or a combination thereof to facilitate calibration or impairment characterization of one or more of the coherent optical transmitter and the coherent optical receiver, wherein an offset between a laser frequency of the coherent optical transmitter and a laser frequency of the coherent optical receiver satisfies a threshold so as to enable the extracting.

Other embodiments are described in the subject disclosure.

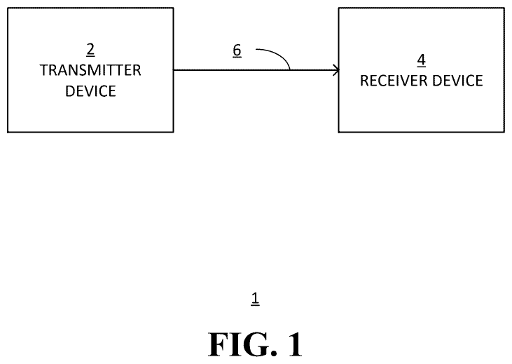

FIG. 1 is a diagram of a non-limiting example of a communication network 1 in accordance with various aspects described herein. The communication network 1 may include at least one transmitter device 2 and at least one receiver device 4. The transmitter device 2 may be capable of transmitting signals over a communication channel, such as a communication channel 6. The receiver device 4 may be capable of receiving signals over a communication channel, such as the communication channel 6. In various embodiments, the transmitter device 2 may also be capable of receiving signals and/or the receiver device 4 may also be capable of transmitting signals. Thus, one or both of the transmitter device 2 and the receiver device 4 may be capable of acting as a transceiver.

The communication network 1 may include additional elements not shown in FIG. 1. For example, the communication network 1 may include one or more additional transmitter devices, one or more additional receiver devices, and one or more other devices or elements involved in the communication of signals in the communication network 1.

In some embodiments, the signals that are transmitted and received in the communication network 1 may include optical signals and/or electrical signals. For example, the transmitter device 2 may be a first optical transceiver, the receiver device 4 may be a second optical transceiver, and the communication channel 6 may be an optical communication channel. In certain embodiments, one or both of the first optical transceiver and the second optical transceiver may be a coherent modem.

In various embodiments, each optical communication channel in the communication network 1 may include one or more links, where each link may include one or more spans, and where each span may include a length of optical fiber and one or more optical amplifiers. Where the communication network 1 involves the transmission of optical signals, the communication network 1 may include additional optical elements not shown in FIG. 1, such as wavelength selective switches, optical multiplexers, optical de-multiplexers, optical filters, and/or the like.

Various elements and effects in an optical link between two communicating devices may result in the degradation of transmitted signals. That is, optical signals received over optical links can become distorted. Particularly, these signals may suffer from polarization mode dispersion (PMD), polarization dependent loss or gain (PDL or PDG), state of polarization (SOP) rotation, amplified spontaneous emission (ASE) noise, wavelength-dependent dispersion or chromatic dispersion (CD), nonlinear noise from propagation through fiber, and/or other effects. For instance, polarization effects of a fiber link tend to rotate the transmitted polarizations such that, at the receiver, they are neither orthogonal to each other nor aligned with the polarization beam splitter of the optical hybrid. As a result, each of the received polarizations (e.g., downstream of the polarization beam splitter) may contain energy from both of the transmitted polarizations, as well as distortions due to CD, PMD, PDL, etc. These problems may be compounded for polarization-division multiplexed signals in which each transmitted polarization contains a respective data signal. The degree of signal degradation due to noise and nonlinearity may be characterized by a signal-to-noise ratio (SNR) or, alternatively, by a noise-to-signal ratio (NSR). The signals transmitted in the communications network may be representative of digital information in the form of bits or symbols. The probability that bit estimates recovered at a receiver differ from the original bits encoded at a transmitter may be characterized by the Bit Error Ratio (BER). As the noise power increases relative to the signal power, the BER may also increase.

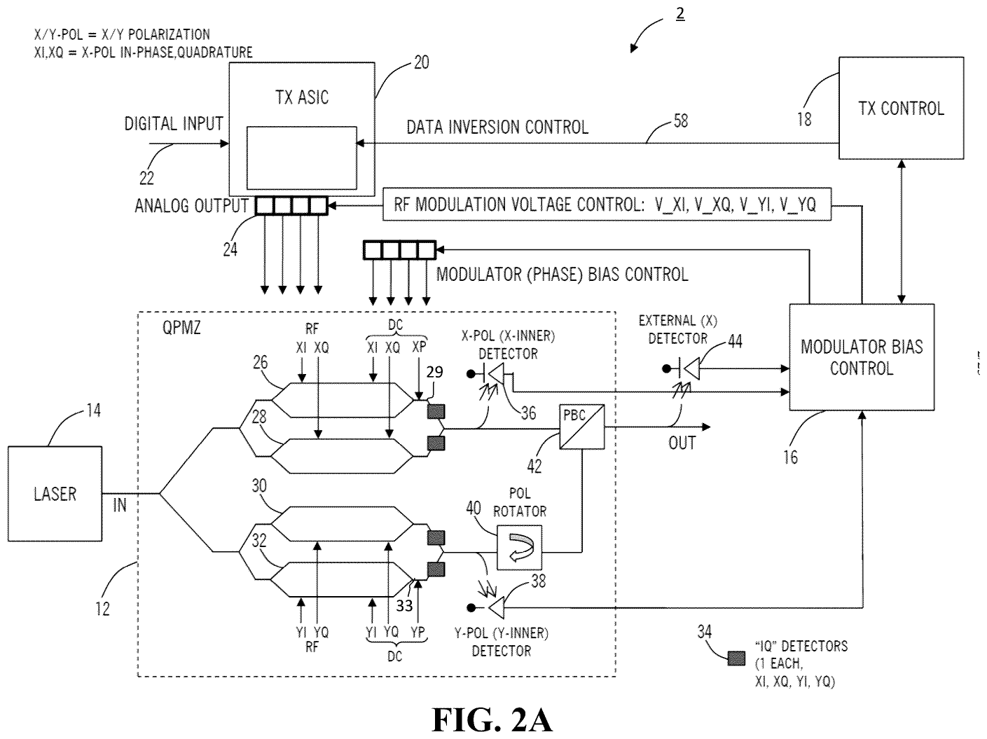

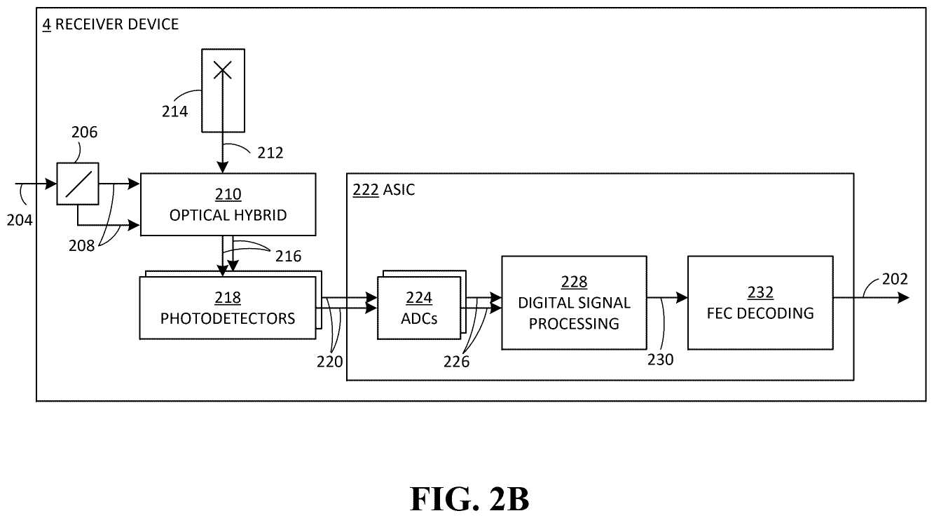

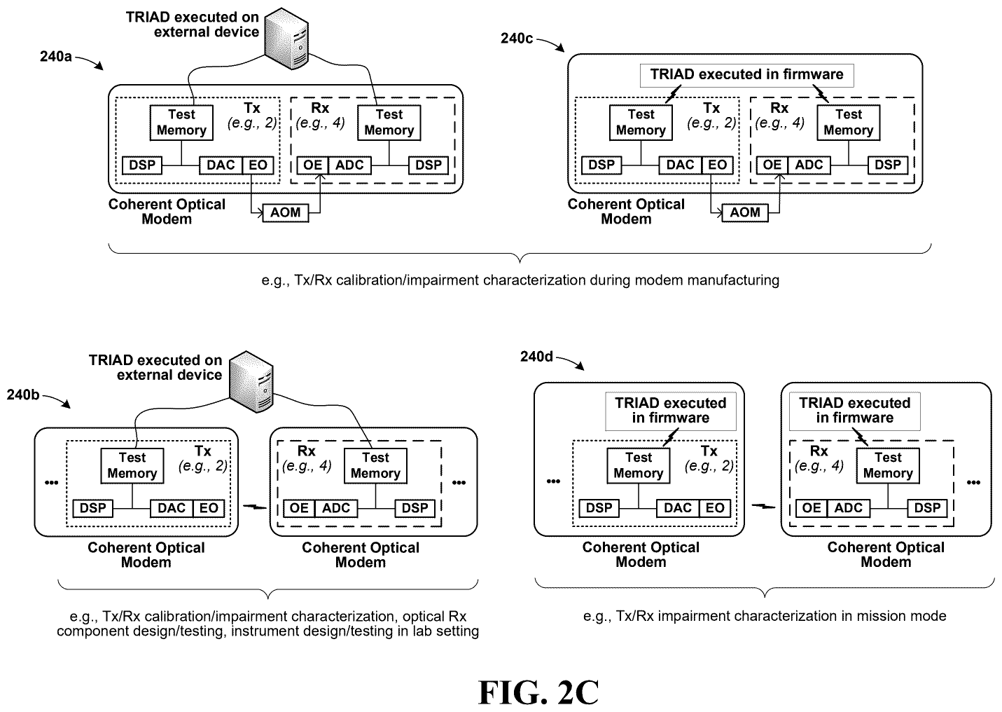

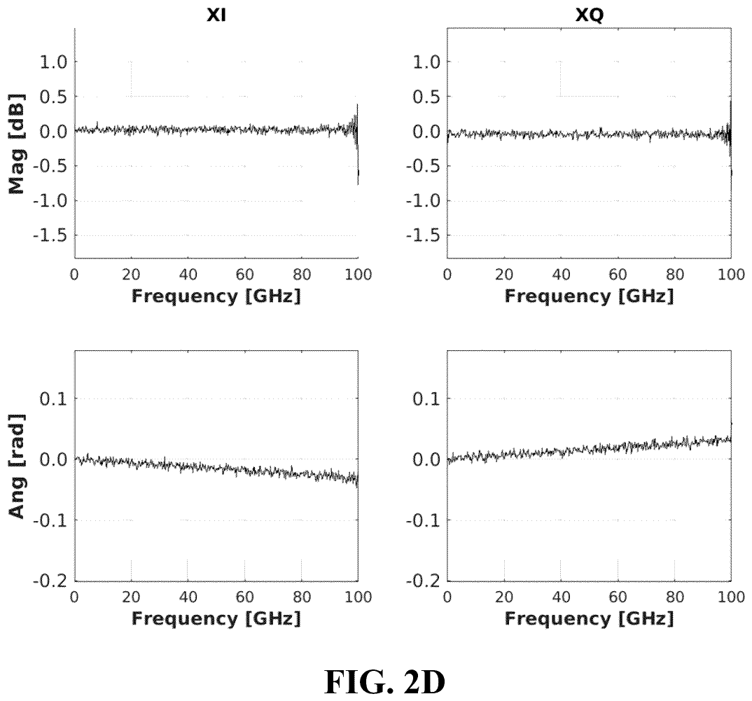

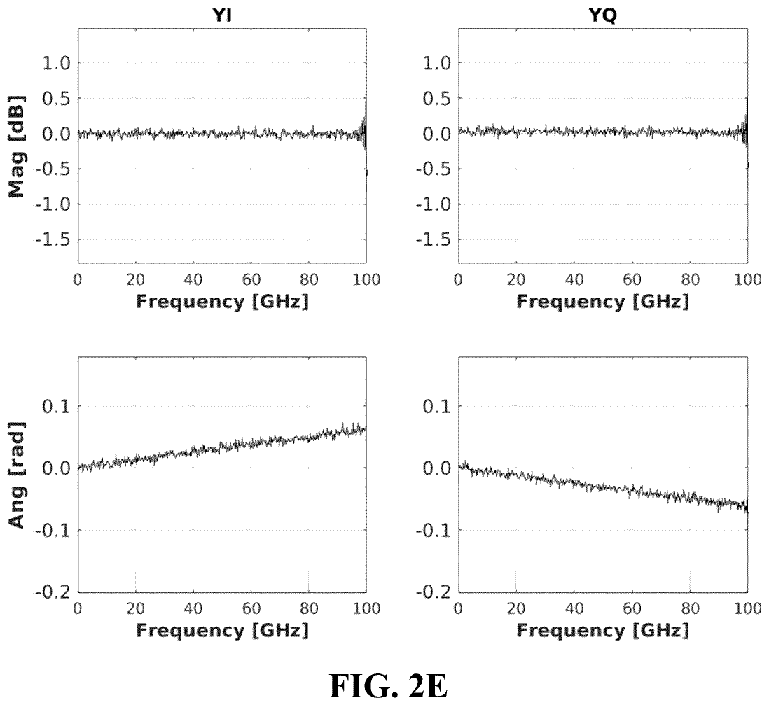

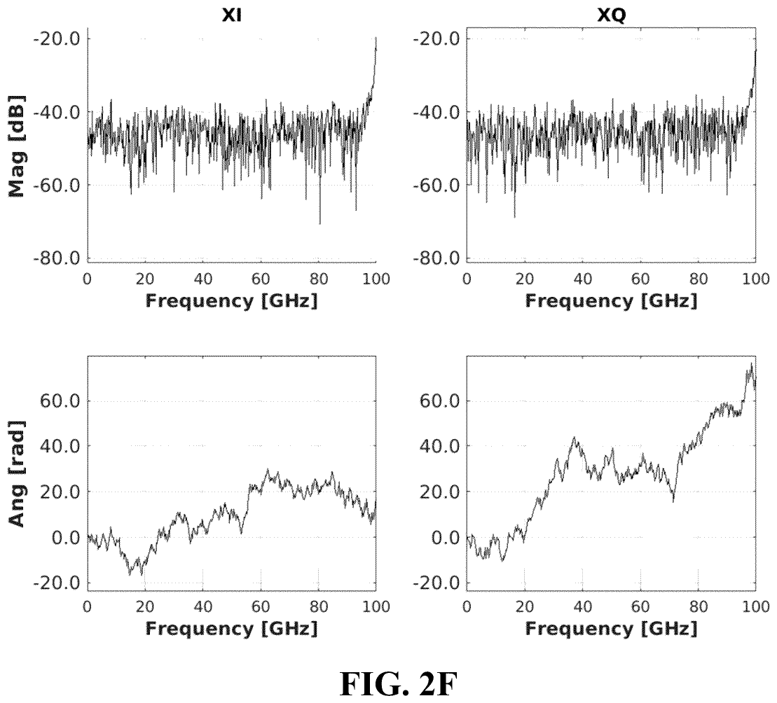

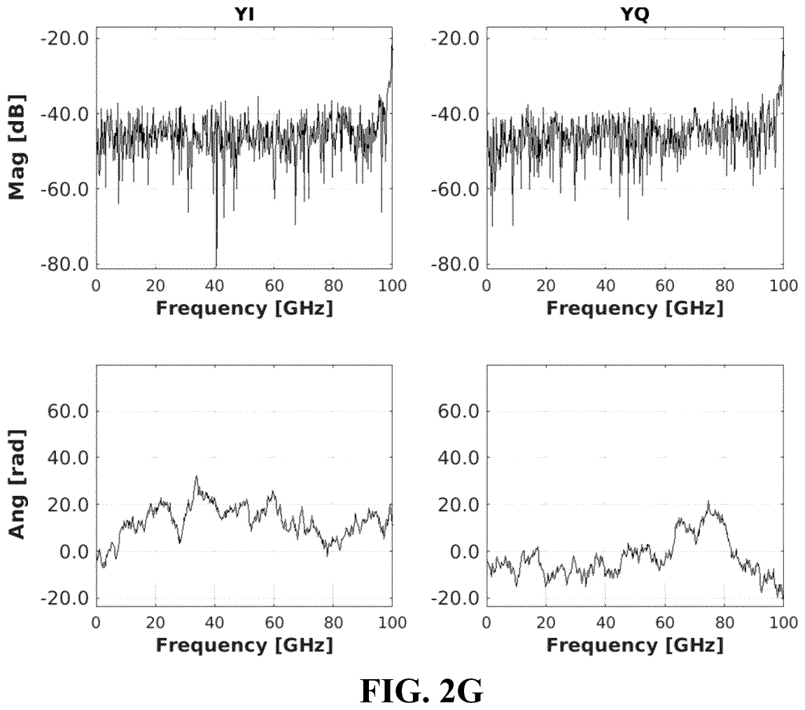

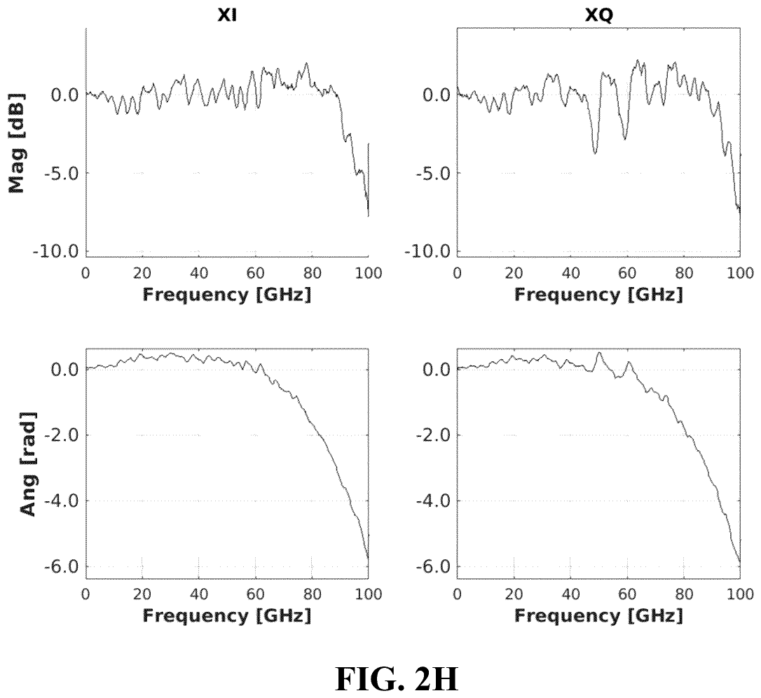

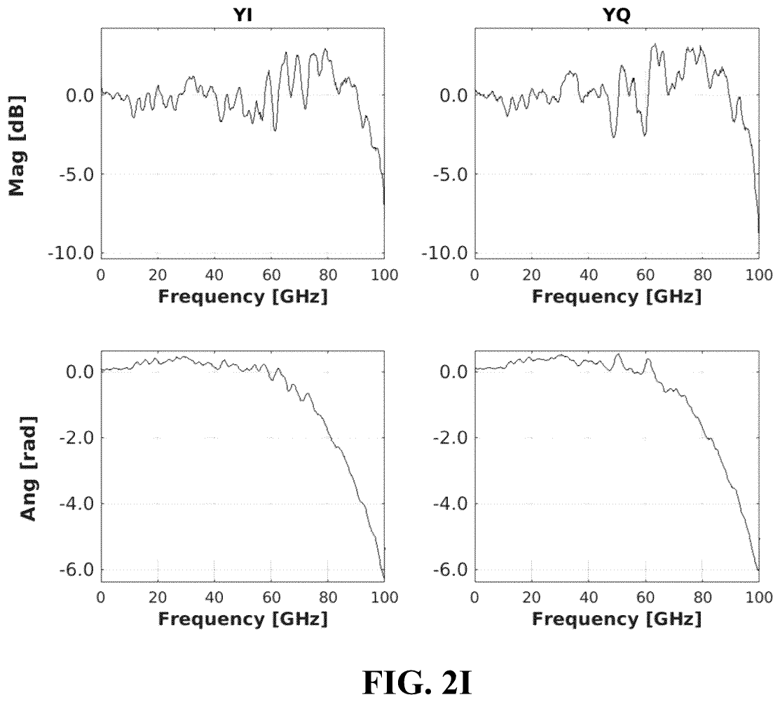

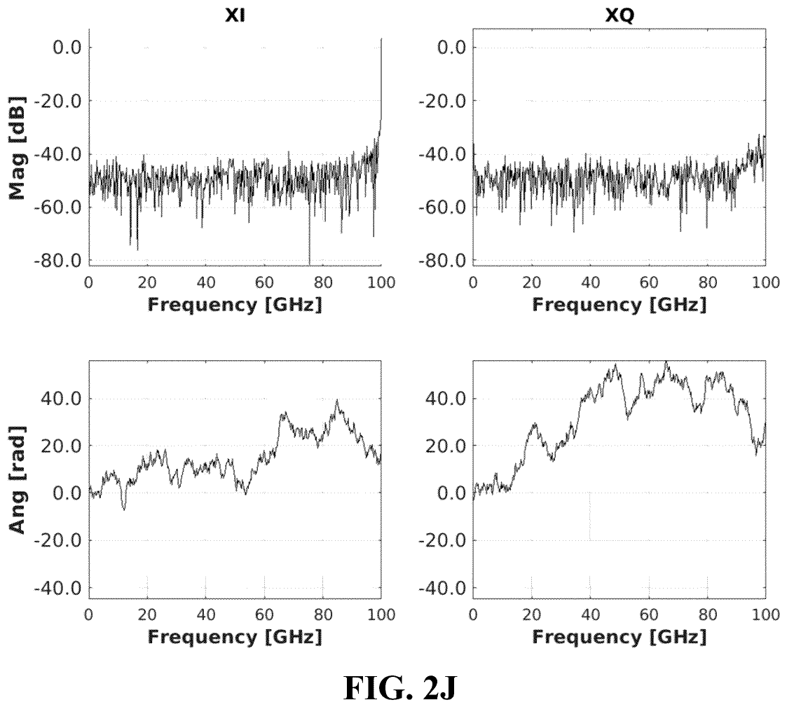

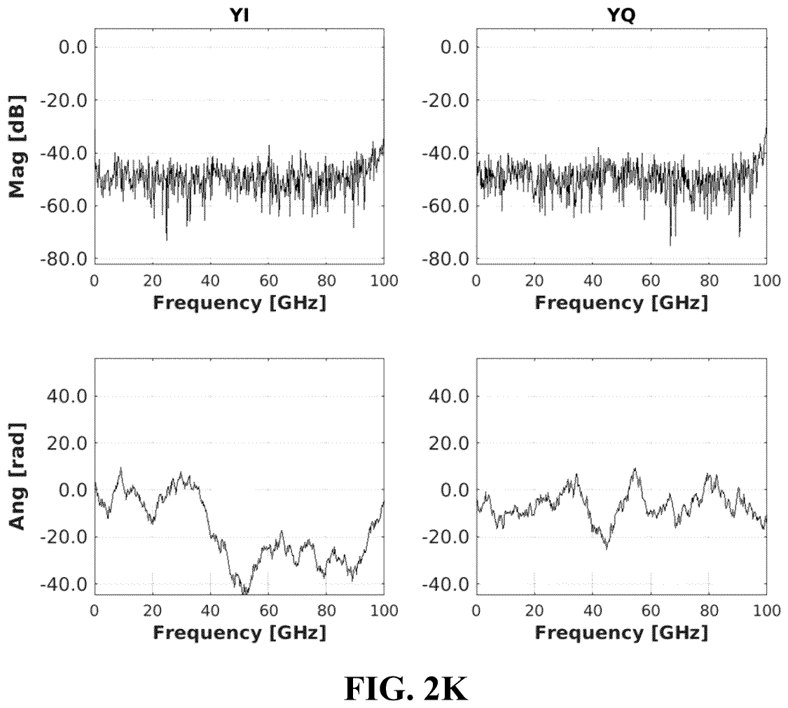

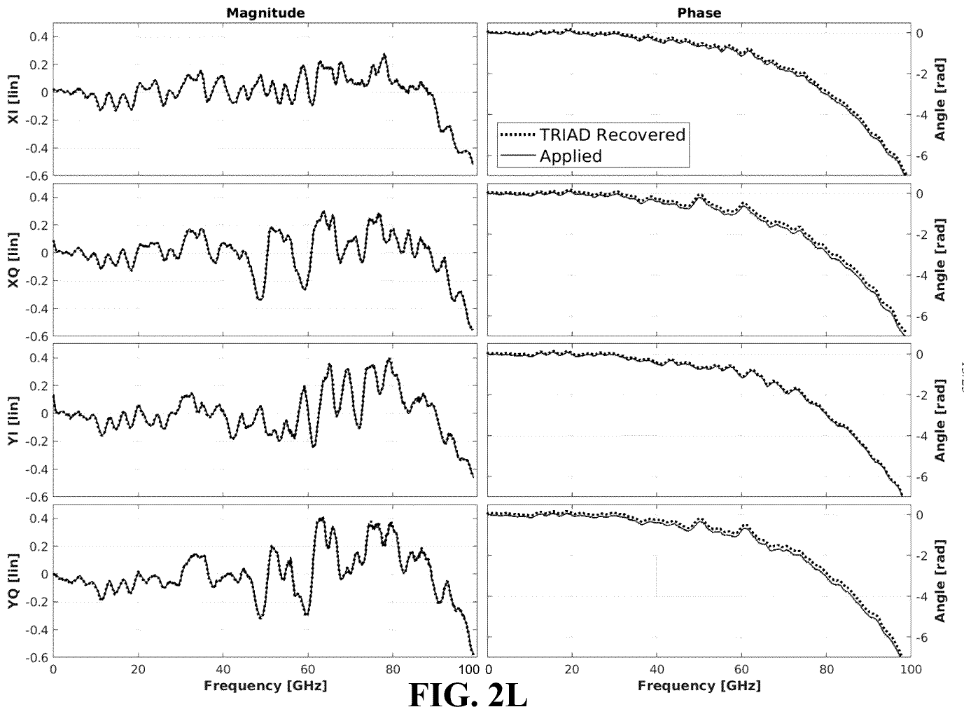

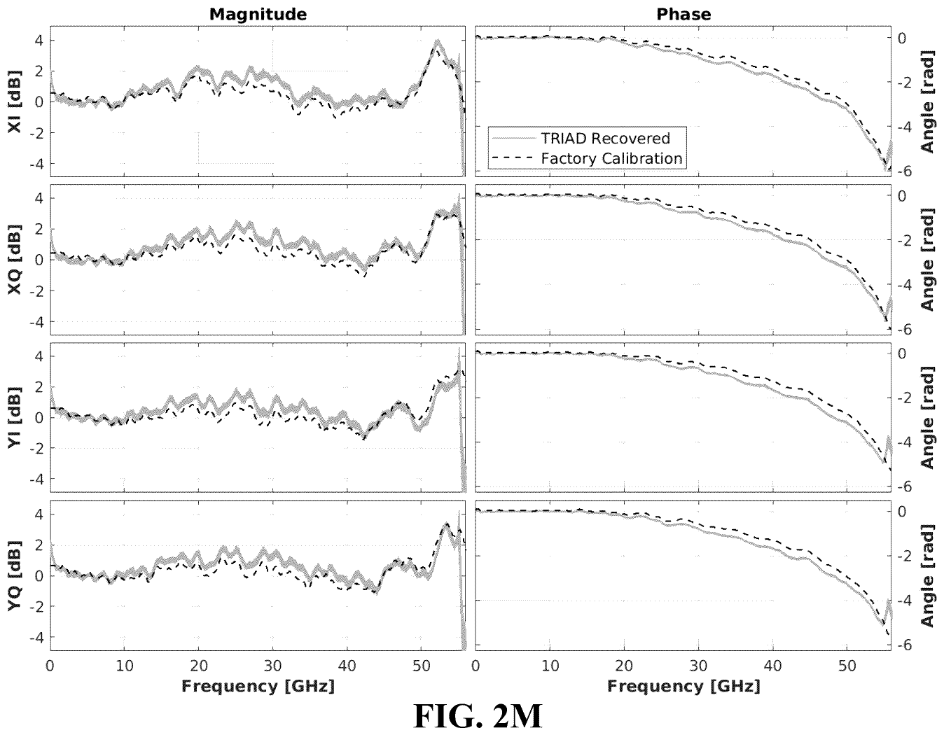

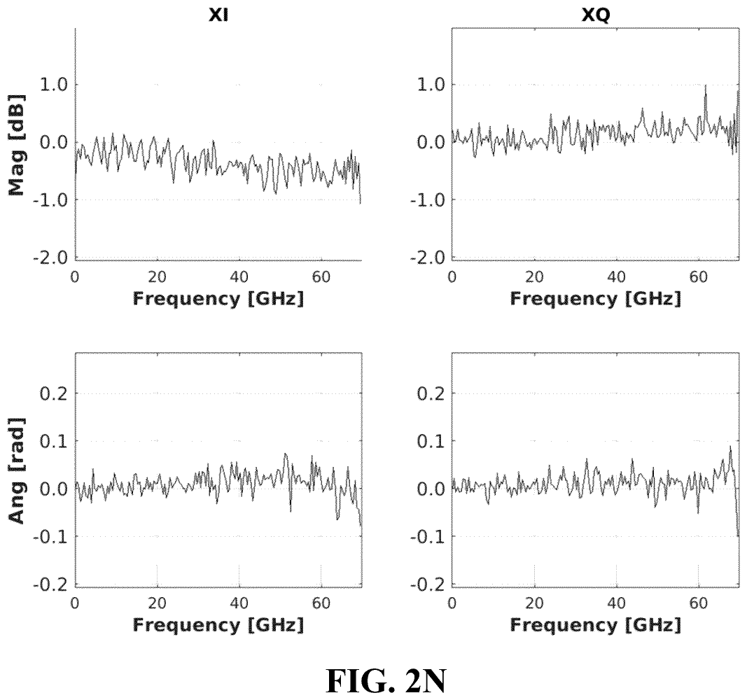

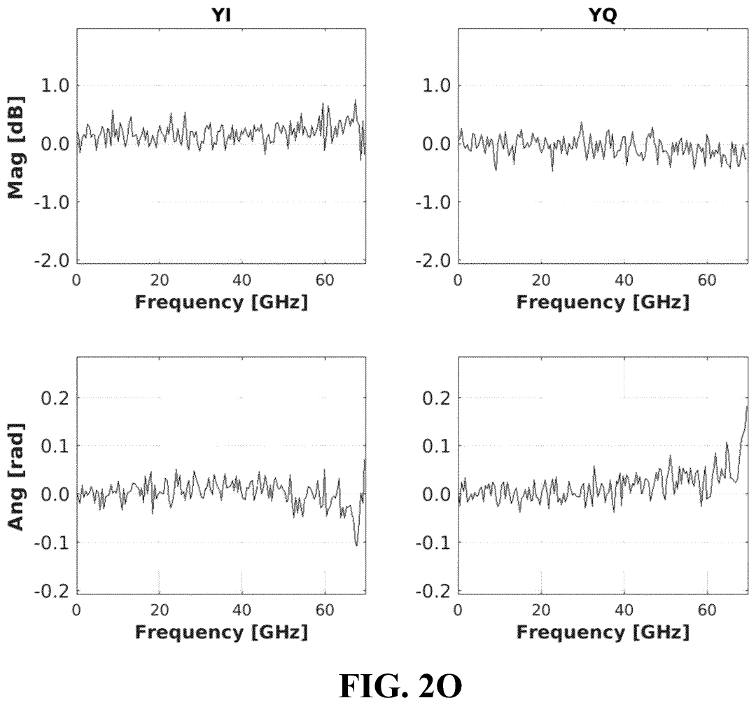

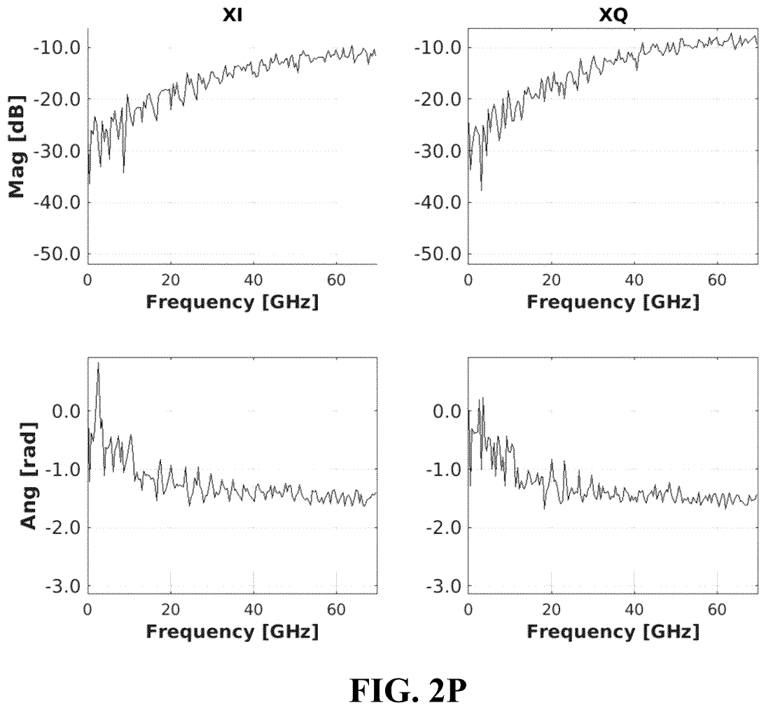

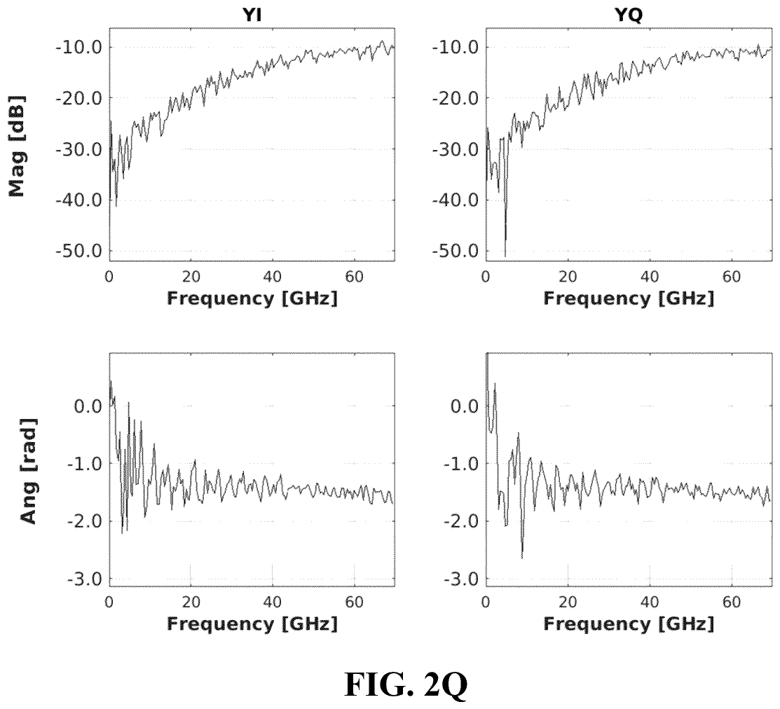

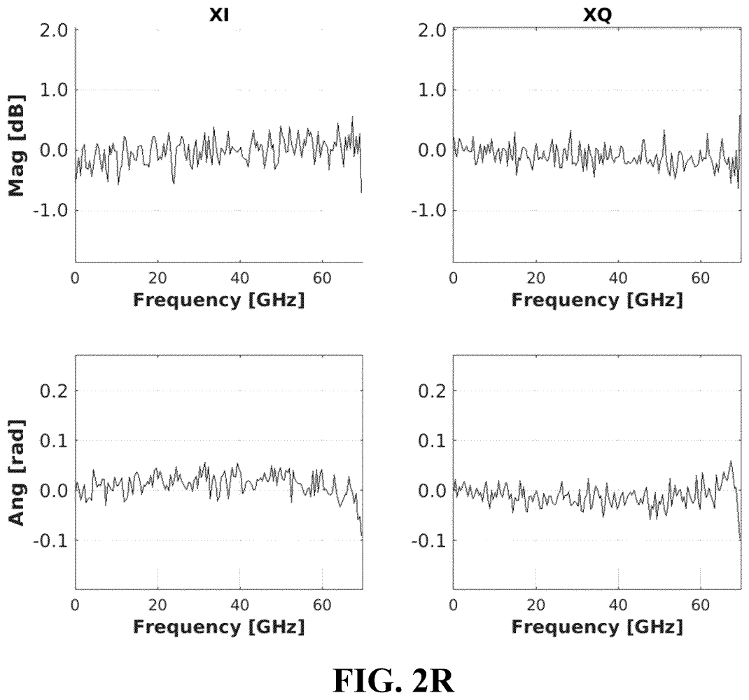

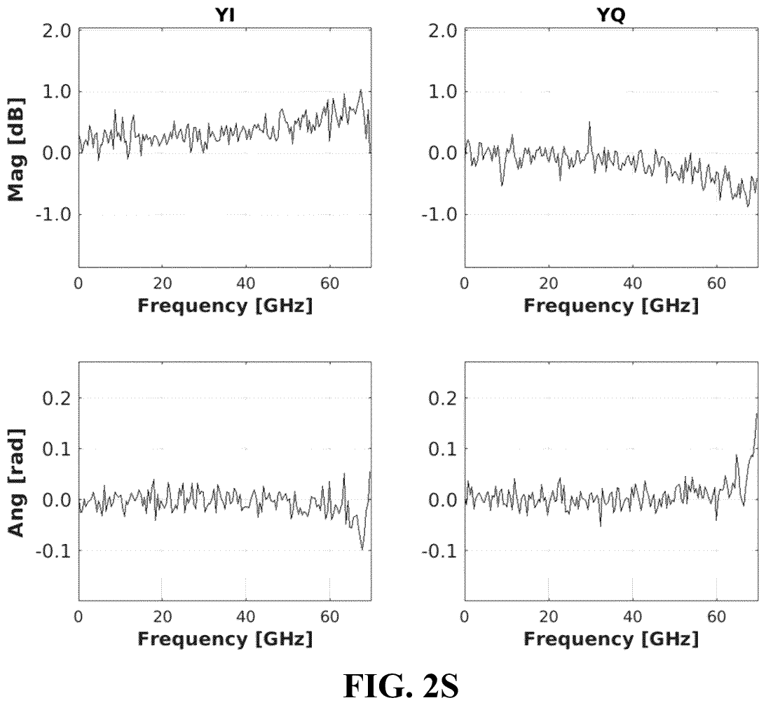

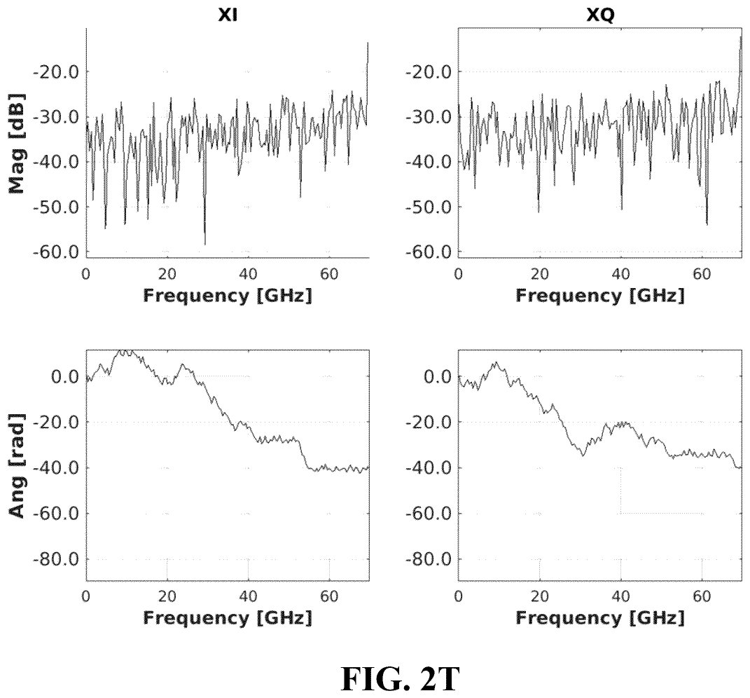

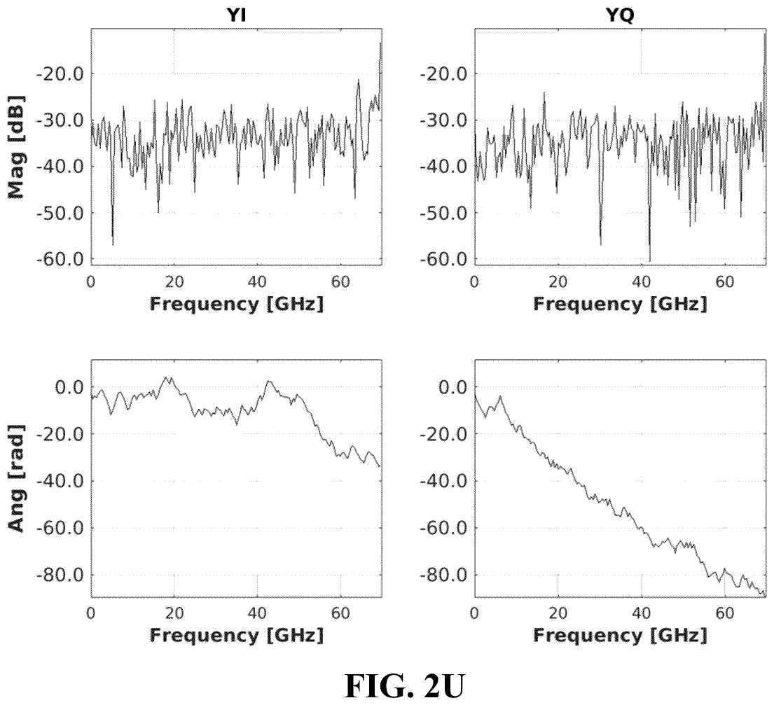

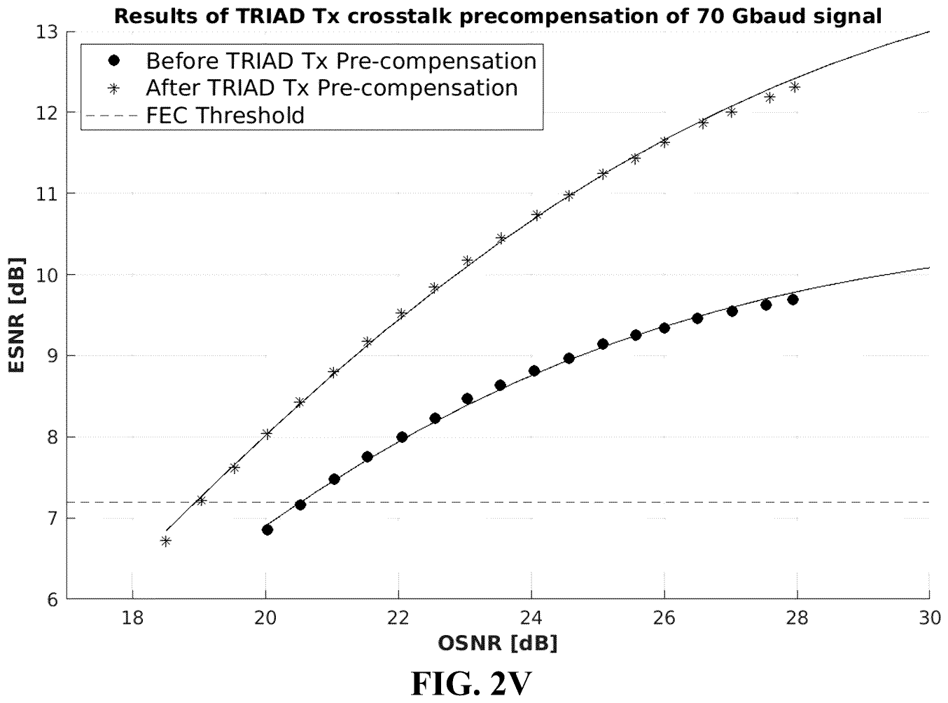

FIG. 2A is a block diagram of an example, non-limiting embodiment of a transmitter/modulator system 2 in accordance with various aspects described herein. As shown in FIG. 2A, the transmitter device 2 may include a combination of optical and electrical components, such as, for example, a modulator 12, a laser 14, a modulator bias controller 16, a transmitter (Tx) controller 18, and a Tx application specific integrated circuit (ASIC) 20. The modulator 12 may employ nested Mach-Zehnder (MZ) architecture(s)—i.e., two dual-parallel MZs (DPMZs), each with two inner MZs and one outer MZ-resulting in a quad parallel MZ (QPMZ) modulator.

In one or more embodiments, the optical modulator system 2 may be equipped to control four quadrature data signals (i.e., radio frequency (RF) XI, RF XQ, RF YI, RF YQ signals, where X, Y denote polarization and I, Q denote in-phase and quadrature, respectively) via the Tx ASIC 20. The modulator 12 may include an XI modulator 26, an XQ modulator 28, and an outer phase modulator 29 (respectively functioning as two inner MZs nested within an outer MZ for the X polarization) as well as a YI modulator 30, a YQ modulator 32, and an outer phase modulator 33 (respectively functioning as two inner MZs nested within an outer MZ for the Y polarization). Each MZ may have one or two DC electrodes depending on the implementation of the MZ. The laser 14 may provide a laser output for modulation by the modulator 12. The laser output may be divided (e.g., via a beam splitter) into X and Y polarizations, where the X polarization may be further divided (e.g., via another beam splitter) into an optical I input that is fed into an X-pol I-arm (i.e., the XI modulator 26) and an optical Q input that is fed into an X-pol Q-arm (i.e., the XQ modulator 28), and where the Y polarization may be further divided (e.g., via yet another beam splitter) into an optical I input that is fed into a Y-pol I-arm (i.e., the YI modulator 30) and an optical Q input that is fed into a Y-pol Q-arm (i.e., the YQ modulator 32). The modulator 12 may be capable of independently generating orthogonal optical electric field components (I channel and Q channel) for each polarization X and Y, according to various types of multi-value modulation methods, such as N-quadrature amplitude modulation (QAM), differential quadrature phase shift keying (D-QPSK), etc.

In general operation, the Tx ASIC 20 may receive a digital information stream at a digital input 22 and convert the digital information stream (based on an associated modulation scheme) for driving the modulator 12 via analog outputs 24 (RF XI, RF XQ, RF YI, RF YQ). The analog outputs 24 may be communicatively coupled to the modulator 12. In some embodiments, the Tx ASIC 20 may include a digital filter that provides a transfer function H on the received digital input 22. A digital-to-analog (D/A) converter may be connected to an output of the digital filter, and an analog amplifier may be connected to an output of the D/A converter to provide a gain G. An output of the analog amplifier may provide the analog output 24 to the modulator 12. In certain embodiments, a controller may be connected to the digital filter and the analog amplifier to control the transfer function H and/or the gain G responsive to a data inversion control signal 58 from the Tx controller 18.

A detector 34 (also referred to as a tap-detector) may be included at an output of each of the modulators 26, 28, 30, 32. In certain embodiments, some or all of the modulators 26, 28, 30, 32 may be referred to as inner modulators and can be amplitude, phase, or mixed phase/amplitude modulators. In one or more embodiments, some or all of the modulators 26, 28, 30, 32 may be phase modulators. As shown, the modulator 12 may include an X-polarization detector 36 that is coupled to a combined output of the modulators 26, 28 (or the output of the outer MZ 29), and a Y-polarization detector 38 that is coupled to a combined output of the modulators 30, 32 (or the output of the outer MZ 33). A polarization rotator 40 may be connected to the combined output of the modulators 30, 32. A polarization beam combiner 42 may be connected to the combined output of the modulators 26, 28 and the combined output of the modulators 30, 32. An output of the polarization beam combiner 42 may provide a modulated output of the modulator 12, and an external detector 44 may be tapped off of the output. The various detectors 34, 36, 38, 44 may be communicatively coupled to the modulator bias controller 16.

As shown in FIG. 2A, several modulator bias points of the modulator 12 may be controlled or optimized via the modulator bias controller 16. In some embodiments, the Tx controller 18 may control the Tx ASIC 20 and/or the modulator bias controller 16. In various embodiments, the Tx controller 18 may control the modulator bias controller 16 in the following ways: (i) open loop control where bias control loops can be opened, enabling direct control of biases and measurement of the detectors 34, 36, 38, 44; and/or (ii) closed loop control where the feedback polarity of the modulator bias controller 16 can be set, but where the modulator bias controller 16 itself implements the feedback control. The Tx controller 18 may identify (e.g., optimum) bias points whereas the modulator bias controller 16 may maintain those points in service. In some embodiments, the modulator bias controller 16 may control the generated analog output signals of the Tx ASIC 20, rather than control bias values of the modulator 12.

FIG. 2B is a block diagram of an example, non-limiting embodiment of a receiver device 4 in accordance with various aspects described herein. In various embodiments, the receiver device 4 may be configured to receive an optical signal 204, which may comprise a degraded version of an optical signal generated by a transmitter device (e.g., the transmitter device 2 of FIG. 1). The optical signal generated by the transmitter device may be representative of information bits (also referred to as client bits) which are to be communicated to the receiver device 4. The optical signal generated by the transmitter device may be representative of a stream of symbols. According to some examples, the transmitter device may be configured to apply forward error correction (FEC) encoding to the client bits to generate FEC-encoded bits, which may then be mapped to one or more streams of data symbols. The optical signal transmitted by the transmitter device may be generated using any of a variety of techniques, such as frequency division multiplexing (FDM), polarization-division multiplexing (PDM), single polarization modulation, modulation of an unpolarized carrier, mode-division multiplexing, spatial-division multiplexing, Stokes-space modulation, polarization balanced modulation, wavelength division multiplexing (WDM) (where a plurality of data streams is transmitted in parallel, over a respective plurality of carriers, and where each carrier is generated by a different laser), and/or the like.

The receiver device 4 may be configured to recover corrected client bits 202 from the received optical signal 204. The receiver device 4 may include a polarizing beam splitter 206 configured to split the received optical signal 204 into polarized components 208. According to one example implementation, the polarized components 208 may include orthogonally polarized components corresponding to an X polarization and a Y polarization. An optical hybrid 210 may be configured to process the components 208 with respect to an optical signal 212 produced by a laser 214, thereby resulting in optical signals 216. Photodetectors 218 may be configured to convert the optical signals 216 output by the optical hybrid 210 to analog electrical signals 220. The frequency difference between the Rx laser and the Tx laser is the Intermediate Frequency, and an offset of that away from nominal can be called fIF. (The nominal difference is usually zero.) According to one example implementation, the analog electrical signals 220 may include four signals corresponding, respectively, to the dimensions XI, XQ, YI, and YQ, where XI and XQ denote the in-phase and quadrature components of the X polarization, and YI and YQ denote the in phase and quadrature components of the Y polarization. Together, elements such as the beam splitter 206, the laser 214, the optical hybrid 210, and the photodetectors 218 may form a communication interface configured to receive optical signals from other devices in a communication network.

As shown in FIG. 2B, the receiver device 4 may include an application specific integrated circuit (ASIC) 222. The ASIC 222 may include analog-to-digital converters (ADCs) 224 that are configured to sample the analog electrical signals 220 and generate respective digital signals 226. In certain alternate embodiments, the ADCs 224 or portions thereof may be separate from the ASIC 222. The ADCs 224 may sample the analog electrical signals 220 periodically at a sample rate that is based on a signal received from a voltage-controlled oscillator (VCO) at the receiver device 4 (not shown). The ASIC 222 may be configured to apply digital signal processing to the digital signals 226 using a digital signal processing system 228. The digital signal processing system 228 may be configured to perform equalization processing that is designed to compensate for a variety of channel impairments, such as CD, SOP rotation, mean PMD that determines the probability distribution which instantiates as differential group delay (DGD), PDL or PDG, and/or other effects. The digital signal processing system 228 may further be configured to perform carrier recovery processing, which may include calculating an estimate of carrier frequency offset fIF (i.e., the difference between the frequency of the transmitter laser and the frequency of the receiver laser 214). According to some example implementations, the digital signal processing system 228 may further be configured to perform operations such as multiple-input-multiple-output (MIMO) filtering, clock recovery, and FDM subcarrier de-multiplexing. The digital signal processing system 228 may also be configured to perform symbol-to-bit demapping (or decoding) using a decision circuit, such that signals 230 output by the digital signal processing system 228 are representative of bit estimates. Where the received optical signal 204 is representative of symbols comprising FEC-encoded bits generated as a result of applying FEC encoding to client bits, the signals 230 may further undergo FEC decoding 232 to recover the corrected client bits 202.

According to some example implementations, the equalization processing implemented as part of the digital signal processing system 228 may include one or more equalizers, some or all of which may be configured to compensate for impairments in the channel response. In general, an equalizer applies a substantially linear filter to an input signal to generate an output signal that is less degraded than the input signal. The filter may be characterized by compensation coefficients which may be incrementally updated from time to time (e.g., every so many clock cycles or every so many seconds) with the goal of reducing the degradation observed in the output signal.

In exemplary embodiments, a bi-directional optical communication system may be implemented with optically-delayed polarization division multiplexing (PDM) at the transmitters, where the receivers may each be equipped with carrier phase recovery (CPR) functionality that independently tracks polarization phases based on synchronization (sync) symbols or time/frequency pilot tones. In each transmitter, the optically-delayed PDM may be provided by way of a (e.g., installed) time delay between two polarizations from the same transmitter laser source, prior to data modulation. Each receiver may be configured to reconstruct a transmitter laser phase noise waveform using DSP and knowledge of the installed time delay.

Below is a detailed description of the TRIAD algorithm, which can be used in a variety of implementations or scenarios. FIG. 2C illustrates several example implementation scenarios involving the TRIAD algorithm in accordance with various aspects described herein.

In one or more embodiments, a portion or the entirety of the TRIAD algorithm may be implemented or run on a computing device that is external to the optical modem(s) under test. This may be applicable in a factory setting during manufacturing of an optical modem, where calibration of the Tx and the Rx of the optical modem is desired, in which case an AOM (and associated electronic signaling generation for triggering the AOM to provide a desired optical frequency offset) may be employed (see 240a of FIG. 2C). This may also be applicable in a lab or test setting for characterizing impairments of the Tx and Rx of different optical modems (e.g., specifically the impairments of optical components of the Rx) or for facilitating the design of optical receive components and/or test instrument(s), in which case an AOM may not be needed (see 240b of FIG. 2C). An arbitrary waveform generator may be used to generate a Tx pattern for uploading to the Tx (or to test memory associated with the Tx, such as the TFET memory) to be transmitted, an oscilloscope may be used to download the received waveform from the Rx (or from test memory associated with the Rx, such as the RFET memory), and the computing device may run the TRIAD algorithm, based on the known Tx pattern and the received waveform data, to facilitate the desired calibration(s)/characterization(s). Or, the computing device may be equipped with functionality for generating the Tx pattern and obtaining the received waveform, in which case the computing device may be communicatively coupled to the Tx to upload the Tx pattern and may be communicatively coupled to the Rx to download the received waveform data.

In certain embodiments, a portion or the entirety of the TRIAD algorithm may be implemented or run on an optical modem itself, such as in firmware of the optical modem. This may be applicable for calibration/impairment characterization purposes in the factory setting during optical modem manufacturing (see 240c of FIG. 2C) or in nominal conditions during use or operation of the optical modem for communications (see 240d of FIG. 2C).

In various embodiments, the laser frequency offset (or the IF), whether provided by way of an AOM or by virtue of two different lasers being used for the Tx and the Rx, may be larger than a threshold that is defined based on the capture device's (e.g., the Rx's) sampling frequency and the size of the memory of the capture device (e.g., the RFET memory). As an example, the laser frequency offset may be at least ten times larger than a value that is equal to the Rx sampling frequency divided by the length of the RFET memory. This guarantees that the received pattern has been rotated by the full [0, 2PI] circle such that any transmit linear impairment per independent I/Q tributaries will be projected onto multiple tributaries in the receiver.

In one or more embodiments, the Tx pattern may need to be large or long enough such that it covers a bandwidth of interest. That is, the Tx pattern may have a period or duration that is long enough to span a desired frequency range. Of course, the TFET memory may need to be large enough store such a Tx pattern. Further, the RFET memory may correspondingly need to be large enough to capture the received pattern (e.g., large enough to capture at least 1000 samples in order to capture the Rx OE linear response with frequency resolution down to 100 MHz for a receiver with 100 GHz bandwidth).

In various embodiments, the TRIAD algorithm may include steps for framing to generally synchronize the Tx and the Rx. The Tx may be triggered to periodically send a known Tx pattern (e.g., in the TFET), which may be a periodic pattern or a pseudo-random pattern. However, because the Rx receives data that is not necessarily synchronous with the transmitted signal, framing is important to align the Tx with the Rx. By knowing the (e.g., periodic) Tx pattern and the offset between the Tx pattern and the Rx captured pattern (e.g., in the RFET), the TRIAD algorithm may circularly shift the Tx pattern until it (e.g., generally) aligns with the Rx captured pattern. It should be noted that, at this stage, we expect Tx/Rx timing-clock jitters and potential parts per million (ppm) offsets (in the case of the Tx and Rx cards being separate) as well as a laser frequency offset, laser linewidth phase noise, unknown Tx/Rx linear responses, optical fiber random SOP rotation, and a small PMD. In order to achieve reliable framing, the Rx captured pattern and the Tx pattern may be split (e.g., divided) into small chunks of contiguous data (e.g., chunks of 100 samples, 200 samples, 1000 samples, etc.). For each chunk of Tx data, we can keep a small subset (e.g., 10 samples, 20 samples, 40 samples, etc.) in or near the middle. Assuming that we have found the right framing position, we can expect such samples in or near the middle to correlate well with the corresponding Rx chunk of data. It is to be understood and appreciated that this method is able to tolerate large delays (in the order of 100 samples) due to large ppm offsets. It can also tolerate large I/Q differential delays. It is also robust against laser impairments (linewidth and IF), as not much phase noise variation is expected within 10 contiguous samples, 20 contiguous samples, 40 contiguous samples, etc.

In one or more embodiments, the TRIAD algorithm may perform detection of potential I/Q flip. For instance, the TRIAD algorithm may determine if I/Q flipping is occurring within the Tx and/or the Rx setup by evaluating direct correlations (Tx and Rx <I, I> and <Q, Q> crosstalk) and/or cross-correlation counterparts (Tx and Rx <I, Q> and <Q, I> crosstalk).

In one or more embodiments, the TRIAD algorithm may perform detection of timing jitter, IF, and laser phase noise. The Tx and Rx pattern may, as noted above, be divided into contiguous chunks (e.g., of size 100, 200, 1000, etc.), and may be respectively represented as s_{X,Y}(b, t), r_{X,Y}(b, t), where b denotes the chunk ID, t denotes the contiguous samples within each chunk, S_{X,Y} denotes the transmitted X/Y polarization pattern, and r_{X,Y} denotes the received X/Y polarization pattern. The Fast Fourier Transform (FFT) may be applied to each chunk:

$${R}_{X , Y} ( b , f ) := {FFT}_{t \to f} \{ {r}_{X , Y} ( b , t ) \}$$

$${S}_{X , Y} ( b , f ) := {FFT}_{t \to f} \{ {s}_{X , Y} ( b , t ) \}$$

The Tx and Rx patterns may be cross-correlated in frequency:

$${H}_{XX} ( b , f ) := {R}_{X} ( b , f ) \cdot {S}_{X}^{*} ( b , f )$$

$${H}_{XY} ( b , f ) := {R}_{X} ( b , f ) \cdot {S}_{Y}^{*} ( b , f )$$

$${H}_{YX} ( b , f ) := {R}_{Y} ( b , f ) \cdot {S}_{X}^{*} ( b , f )$$

$${H}_{YY} ( b , f ) := {R}_{Y} ( b , f ) \cdot {S}_{Y}^{*} ( b , f )$$

Cross-correlation results may be averaged over a chunk (L=10 . . . 100) of contiguous frequency bins in order to average out and smear additive noise:

$${\tilde{H}}_{XX} ( b , f ) := {\sum }_{{f}^{′} = f - \frac{L}{2}}^{f + \frac{L}{2}} {H}_{XX} ( b , {f}^{′} )$$

$${\tilde{H}}_{XY} ( b , f ) := {\sum }_{{f}^{′} = f - \frac{L}{2}}^{f + \frac{L}{2}} {H}_{XY} ( b , {f}^{′} )$$

$${\tilde{H}}_{YX} ( b , f ) := {\sum }_{{f}^{′} = f - \frac{L}{2}}^{f + \frac{L}{2}} {H}_{YX} ( b , {f}^{′} )$$

$${\tilde{H}}_{YY} ( b , f ) := {\sum }_{{f}^{′} = f - \frac{L}{2}}^{f + \frac{L}{2}} {H}_{YY} ( b , {f}^{′} )$$

The determinant of the 2×2 matrix I may be calculated per frequency bin of each chunk of data:

$$D ( b , f ) := {\tilde{H}}_{XX} ( b , f ) \cdot {\tilde{H}}_{YY} ( b , f ) - {\tilde{H}}_{XY} ( b , f ) \cdot {\tilde{H}}_{YX} ( b , f )$$

The angle of the determinant may also be calculated per frequency bin of each chunk of data:

$$θ ( b , f ) := Angle ( D ( b , f ) )$$

For each chunk of data (that is, for each value of b), a linear phase ramp as a function of frequency f may be fitted to the measured phase θ(b, f):

$$θ ( b , f ) \approx 2 π f \cdot τ ( b ) + ϕ ( b ) ,$$

where the value of τ(b) determines the clock timing offset corresponding to chunk b, and where the value of ϕ(b) determines the laser phase noise corresponding to chunk b. Note that the determinant operation helps to remove the impact of optical impairments, such as SOP rotation and PMD. The transmitted pattern S_{X,Y}(t) may then be modulated by the detected sampling-clock-offset and the laser frequency error value as follows:

$$\begin{matrix}{\hat{s}}_{X} ( t ) := {s}_{X} ( t - τ ( t ) ) \cdot {e}^{j ϕ ( t )} \\ {\hat{s}}_{Y} ( t ) := {s}_{Y} ( t - τ ( t ) ) \cdot {e}^{j ϕ ( t )} ,\end{matrix}$$

where ϕ(t) denotes the laser phase noise (due to IF and linewidth) corresponding to sample t, which is calculated in the previous stage, and where τ(t) denotes the ADC sampling clock offset (with respect to the DAC) corresponding to sample t, which is calculated in the previous stage. The aim is to bring the transmitted pattern to the same clock-phase and laser-phase domain as the received pattern. Hence, all transmit I/Q impairments would be spinning due to phase modulation and will act as random noise (instead of a deterministic impairment).

Receiver impairments may be learned by relying on the ideal phase/time modulated/offsetted transmit pattern ŝ_{X}(t), ŝ_{Y}(t) and the received pattern r_{X}(t), r_{Y}(t). Note that, here, the receiver linear transfer function as well as the optical fiber linear transfer function may be jointly learned. The TRIAD algorithm may learn a 2×2 matrix of complex finite impulse response (FIR) taps corresponding to the fiber transfer function

$$G := [ \begin{matrix}{g}_{XX} ( t ) & {g}_{XY} ( t ) \\ {g}_{YX} ( t ) & {g}_{YY} ( t )\end{matrix} ]$$

(corresponding to potential SOP rotation, PMD, and PDL) as well as a 4×4 matrix of real FIR taps corresponding to the transfer function of the Rx

$$chain F := [ \begin{matrix}{F}_{XI , XI} ( t ) & {F}_{XI , XQ} ( t ) & {F}_{XI , YI} ( t ) & {F}_{XI , YQ} ( t ) \\ {F}_{XQ , XI} ( t ) & {F}_{XQ , XQ} ( t ) & {F}_{XQ , YI} ( t ) & {F}_{XQ , YQ} ( t ) \\ {F}_{YI , XI} ( t ) & {F}_{YI , XQ} ( t ) & {F}_{YI , YI} ( t ) & {F}_{YI , YQ} ( t ) \\ {F}_{YQ , XI} ( t ) & {F}_{YQ , XQ} ( t ) & {F}_{YQ , YI} ( t ) & {F}_{YQ , YQ} ( t )\end{matrix} ] .$$

It should be noted that the diagonal elements of matrix F determine the linear response of receiver I/Q paths as well as any potential I/Q differential delays within the receiver chain. The off-diagonal elements of matrix F determine potential Rx QE as well as crosstalk between different tributaries. Learning of the fiber and Rx chain transfer functions may be implemented using well-known methods, such as the LMS filter method, Wiener filters, and/or Kalman filters. A good learning attempts to minimize power of fitting error:

$${min}_{F , G} {\vert ( \begin{matrix}{r}_{XI} ( t ) \\ {r}_{XQ} ( t ) \\ {r}_{YI} ( t ) \\ {r}_{YQ} ( t )\end{matrix} ) - F * {G}_{r} * ( \begin{matrix}{\hat{s}}_{XI} ( t ) \\ {\hat{s}}_{XQ} ( t ) \\ {\hat{s}}_{YI} ( t ) \\ {\hat{s}}_{YQ} ( t )\end{matrix} ) \vert}^{2}$$

Following learning of linear impairments of the Rx OE chain, high-order nonlinearities of the Rx OE chain, such as 3^{rd} Harmonic nonlinearities may be learned. Defining the ideal linear-impaired Rx signal as

$${\overline{r}}_{Linear} := F * {G}_{r} * ( \begin{matrix}{\hat{s}}_{XI} ( t ) \\ {\hat{s}}_{XQ} ( t ) \\ {\hat{s}}_{YI} ( t ) \\ {\hat{s}}_{YQ} ( t )\end{matrix} ) ,$$

the TRIAD algorithm may learn the nonlinear (NL) function such that

$${min}_{NL ( {\overline{r}}_{Linear} )} \vert \overline{r} - {\overline{r}}_{Linear} - N L ( {\overline{r}}_{Linear} ) \vert ,$$

where NL(r̅ Linear) denotes the nonlinear function to be learned. In any case, the receiver pattern may be backpropagated in the RX OE chain and fiber by undoing the linear effect of the RX OE chain, the effect of laser phase noise, and the effect of timing jitter:

$$( \begin{matrix}{\hat{r}}_{XI} ( t ) \\ {\hat{r}}_{XQ} ( t ) \\ {\hat{r}}_{YI} ( t ) \\ {\hat{r}}_{YQ} ( t )\end{matrix} ) = ( ( {G}^{- 1} * {F}^{- 1} * ( \begin{matrix}{r}_{XI} ( t ) \\ {r}_{XQ} ( t ) \\ {r}_{YI} ( t ) \\ {r}_{YQ} ( t )\end{matrix} ) ) \cdot {e}^{- j ϕ ( t )} ) * δ ( t + τ ( t ) )$$

Here, the 4×4 real multiple-input-multiple-output (MIMO) FIR F⁻¹ inverts the linear impact of the Rx OE chain matrix F, while the 2×2 complex MIMO FIR G⁻¹ inverts the impact of optical fiber matrix G. Furthermore, the term e^{-jϕ(t)} undoes the laser phase modulation, while the term δ(t+τ(t)) undoes the impact of ADC clock timing offset, where & (t) denotes the Dirac delta function. In other words, the received waveforms of the various tributaries XI, XQ, YI, YQ at the ADC output may be convolved with the inverse of the Rx OE chain response (F⁻¹) and the inverse of the optical channel (G⁻¹), demodulated by the laser frequency (e^{-jϕ(t)}), and convolved with the delta function (δ(t+τ(t))) (to remove the impact of clock jitter), so as to backpropagate the received pattern to an \hat{r} waveform that would be expected at the DAC output, including the Tx linear and nonlinear impairments.

In various embodiments, the TRIAD algorithm may learn Tx impairments using the received backpropagated waveform \hat{r} and the ideal Tx programmed pattern s. First, the linear impairments may be learned by way of a 4×4 matrix of real FIR taps corresponding to the transfer function of Tx chain

$$K := [ \begin{matrix}{K}_{XI , XI} ( t ) & {K}_{XI , XQ} ( t ) & {K}_{XI , YI} ( t ) & {K}_{XI , YQ} ( t ) \\ {K}_{XQ , XI} ( t ) & {K}_{XQ , XQ} ( t ) & {K}_{XQ , YI} ( t ) & {K}_{XQ , YQ} ( t ) \\ {K}_{YI , XI} ( t ) & {K}_{YI , XQ} ( t ) & {K}_{YI , YI} ( t ) & {K}_{YI , YQ} ( t ) \\ {K}_{YQ , XI} ( t ) & {K}_{YQ , XQ} ( t ) & {K}_{YQ , YI} ( t ) & {K}_{YQ , YQ} ( t )\end{matrix} ]$$

Notice that the diagonal elements of matrix K determine the linear response of transmit I/Q paths as well as any potential I/Q differential delays within the transmit chain. The off-diagonal elements of matrix K determine potential Tx QE as well as crosstalk between different tributaries. Learning of the Tx transfer function may be implemented using well-known methods, such the LMS filter method, Wiener filters, and/or Kalman filters. A good learning attempts to minimize the power of fitting error:

$${min}_{K} {\vert ( \begin{matrix}{\hat{r}}_{XI} ( t ) \\ {\hat{r}}_{XQ} ( t ) \\ {\hat{r}}_{YI} ( t ) \\ {\hat{r}}_{YQ} ( t )\end{matrix} ) - K * ( \begin{matrix}{s}_{XI} ( t ) \\ {s}_{XQ} ( t ) \\ {s}_{YI} ( t ) \\ {s}_{YQ} ( t )\end{matrix} ) \vert}^{2}$$

Following learning of the linear impairments of the Tx EO chain, high-order nonlinearities of the Tx EO chain, such as 3^{rd} Harmonic nonlinearities may be learned. Defining the ideal linear-impaired Tx signal as

$${\overline{s}}_{Linear} := K * ( \begin{matrix}{s}_{XI} ( t ) \\ {s}_{XQ} ( t ) \\ {s}_{YI} ( t ) \\ {s}_{YQ} ( t )\end{matrix} ) ,$$

the TRIAD algorithm may learn the NL function such that

$${min}_{NL ( {\overline{s}}_{Linear} )} \vert \overline{\hat{r}} - {\overline{s}}_{Linear} - N L ( {\overline{s}}_{Linear} ) \vert ,$$

where NL (s̅_{Linear}) denotes the nonlinear function to be learned. Any deterministic DAC distortion source, such as gain/timing mismatches, duty-cycle distortion, etc. can similarly be learned. That is, after the backpropagation, other distortions relating to the DAC in the Tx may be learned similarly to the way that nonlinearities of the Tx can be learned.

It will be understood and appreciated that learning of nonlinear impairments may be optional depending on the application. Thus, steps of the TRIAD algorithm described above that relate to learning of nonlinear impairments may be excluded if only the learning of linear impairments is desired.

In various embodiments, the TRIAD algorithm can also be used to estimate (e.g., any) residual linear impairments that remain after initial Tx/Rx calibration. Examples may include any residual Tx and/or Rx differential IQ delay as well as any residual IQ QE for the Tx EO and/or the Rx OE. Such measurements may be useful for characterizing system calibration changes as a function of temperature or other environmental variables, particularly since system calibration is typically performed at one temperature (or under a set of environmental conditions) and system variations are expected with changing environmental conditions. In order to learn residual linear impairments, the initially learned linear impairments may be applied to Tx and Rx waveforms.

As an example,

$${F}_{( Rx , init )}^{( - 1 )}$$

may be applied to the Rx waveform, where F_{(Rx,init)} denotes the initially learned Rx OE linear response (such as the initial Rx QE/differential delay/etc.), as

$${F}_{( Rx , init )}^{( - 1 )} * ( \begin{matrix}{r}_{XI} ( t ) \\ {r}_{XQ} ( t ) \\ {r}_{YI} ( t ) \\ {r}_{YQ} ( t )\end{matrix} )$$

prior to estimation of a 4×4 matrix F that now determines or reveals any residual Rx OE linear impairments.

Similarly, an (e.g., any) initially learned Tx linear impairment 4×4 matrix K_{(Tx,init)} may be applied to the Tx waveform prior to learning the residual Tx linear impairments:

$${min}_{K} {\vert ( \begin{matrix}{\hat{r}}_{XI} ( t ) \\ {\hat{r}}_{XQ} ( t ) \\ {\hat{r}}_{YI} ( t ) \\ {\hat{r}}_{YQ} ( t )\end{matrix} ) - K * {K}_{( Tx , init )} * ( \begin{matrix}{s}_{XI} ( t ) \\ {s}_{XQ} ( t ) \\ {s}_{YI} ( t ) \\ {s}_{YQ} ( t )\end{matrix} ) \vert}^{2}$$

Under such scenario, the learned 4×4 matrix K would then determine or reveal any residual Tx EO linear impairments.

FIGS. 2D to 2V show example simulation and experimental results relating to use of the TRIAD algorithm. In the example simulations, an intentionally large frequency offset (i.e., a large IF) was applied between the Tx and Rx lasers. The graphs in FIGS. 2D to 2G show results of Rx calibration simulation using the TRIAD algorithm, where a calibrated Tx was used with certain impairments, a typical optical signal-to-noise ratio (OSNR) of 40 decibels (dB), particular jitter, particular Tx/Rx I/Q skews, particular Tx/Rx I/Q power imbalance, a particular Rx frequency and phase response, and a laser linewidth of 100 kiloHertz (kHz). In the simulation, the Tx was adjusted to exhibit impairments typical to a reference or “golden” Tx. Subsequently, the focus was on the Rx where the TRIAD algorithm was used to determine the Rx transfer function and residual Tx impairments. FIGS. 2D and 2E show the residual transfer function (of the four tributaries) of the simulated Tx, and FIGS. 2F and 2G show the recovered Tx crosstalk. FIGS. 2H and 2I show the linear transfer function (of the four tributaries) of the simulated Rx, and FIGS. 2J and 2K show the recovered Rx crosstalk. Individual linear responses of the four tributaries of the Rx (i.e., the Rx transfer function installed in the simulation) are shown as magnitude and phase components in FIG. 2L as solid lines. As can be seen in these graphs, the TRIAD algorithm enabled correct recovery of the Rx transfer function and residual I/Q delays of the transmitter that were installed in the simulation. The TRIAD recovered transfer functions (of the four tributaries) are shown using dotted lines in FIG. 2L.

The graphs in FIG. 2M show results of laboratory measurements of TRIAD-based calibration (in a homodyne configuration using an AOM to achieve the necessary IF shift) as compared to those of a conventional calibration procedure. As illustrated in FIG. 2M, TRIAD-based calibration was repeated fifty times to confirm repeatability, comparing well with the existing calibration method. The laboratory measurements were performed using a commercial modem and a factory calibration test station.

The graphs in FIGS. 2N to 2V relate to a laboratory experiment in which the TRIAD algorithm was used to characterize impairments of an example prototype Tx exhibiting poor performance. The TRIAD method was instrumental in quickly diagnosing the underlying condition, specifically large Tx IQ crosstalk. FIGS. 2N and 2O show the residual Tx transfer function (of the four tributaries) measured using the TRIAD algorithm, and FIGS. 2P and 2Q show measured crosstalk of the prototype Tx. The results indicate up to −10 dB of crosstalk at frequencies above 60 GHz. FIGS. 2R and 2S show the residual Tx transfer function (of the four tributaries) and FIGS. 2T and 2U show the residual Tx crosstalk levels, after TRIAD-based pre-compensation was applied. Following pre-compensation, the crosstalk level was below-30 dB. FIG. 2V shows modem performance measurements (i.e., electrical SNR, or ESNR, vs. OSNR) before (shown using solid circle symbols) and after (shown using asterisk ‘*’ symbols) TRIAD Tx crosstalk pre-compensation was applied. The applied crosstalk pre-compensation resulted in 3.6 dB improvement in measured internal noise and 1.57 dB reduction in required OSNR.

It is to be understood and appreciated that, although one or more of FIGS. 1 and 2A-2C might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various elements, components, devices, systems, modules, circuits, etc. may have been illustrated in one or more of FIGS. 1 and 2A-2C as separate elements, components, devices, systems, modules, circuits, etc., it will be appreciated that multiple elements, components, devices, systems, modules, circuits, etc. can be implemented as a single element, component, device, system, module, circuit, etc., or a single element, component, device, system, module, circuit, etc. can be implemented as multiple elements, components, devices, systems, modules, circuits, etc. Additionally, functions described as being performed by one element, component, device, system, module, circuit, etc. may be performed by multiple elements, components, devices, systems, modules, circuits, etc., or functions described as being performed by multiple elements, components, devices, systems, modules, circuits, etc. may be performed by a single element, component, device, system, module, circuit, etc.

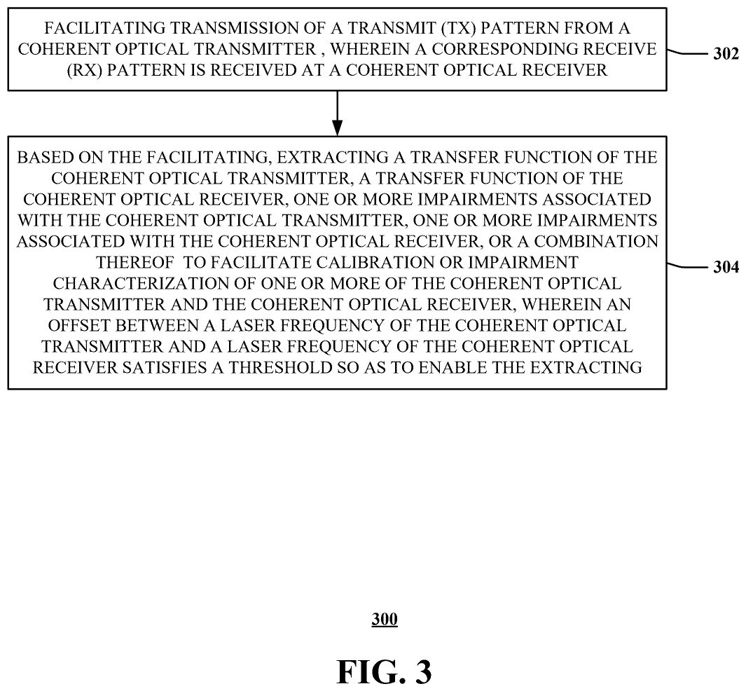

FIG. 3 depicts an illustrative embodiment of a method 300 in accordance with various aspects described herein.

At 302, the method can include facilitating transmission of a transmit (Tx) pattern from a coherent optical transmitter, wherein a corresponding receive (Rx) pattern is received at a coherent optical receiver. For example, the TRIAD algorithm can, similar to that described above with respect to at least FIG. 2C, perform one or more operations that include facilitating transmission of a transmit (Tx) pattern from a coherent optical transmitter, wherein a corresponding receive (Rx) pattern is received at a coherent optical receiver.

At 304, the method can include based on the facilitating, extracting a transfer function of the coherent optical transmitter, a transfer function of the coherent optical receiver, one or more impairments associated with the coherent optical transmitter, one or more impairments associated with the coherent optical receiver, or a combination thereof to facilitate calibration or impairment characterization of the coherent optical transmitter, the coherent optical receiver, or both, wherein an offset between a laser frequency of the coherent optical transmitter and a laser frequency of the coherent optical receiver satisfies a threshold so as to enable the extracting. For example, the TRIAD algorithm can, similar to that described above with respect to at least FIG. 2C, perform one or more operations that include based on the facilitating, extracting a transfer function of the coherent optical transmitter, a transfer function of the coherent optical receiver, one or more impairments associated with the coherent optical transmitter, one or more impairments associated with the coherent optical receiver, or a combination thereof to facilitate calibration or impairment characterization of one or more of the coherent optical transmitter and the coherent optical receiver, wherein an offset between a laser frequency of the coherent optical transmitter and a laser frequency of the coherent optical receiver satisfies a threshold so as to enable the extracting.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

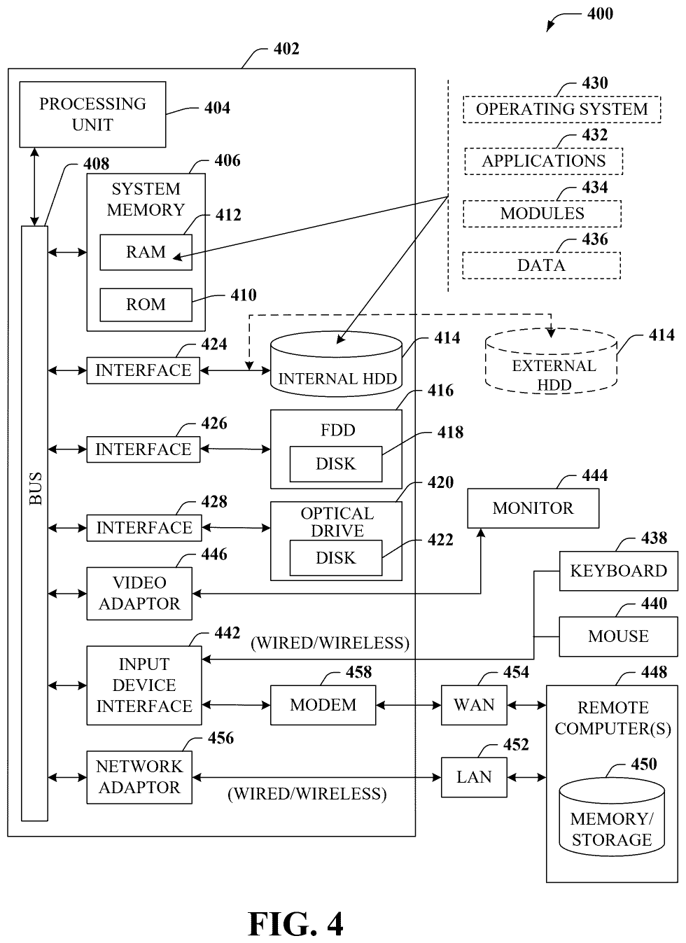

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. For example, computing environment 400 can facilitate in whole or in part transmitter-receiver intermediate frequency (IF)-assisted decomposition of system transfer function(s).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising
based on a transmission of a transmit (Tx) pattern from a coherent optical transmitter and a receipt of a corresponding receive (Rx) pattern at a coherent optical receiver, extracting a transfer function of the coherent optical transmitter, a transfer function of the coherent optical receiver, one or more impairments associated with the coherent optical transmitter, one or more impairments associated with the coherent optical receiver, or a combination thereof to facilitate calibration or impairment characterization of one or more of the coherent optical transmitter and the coherent optical receiver,
wherein an offset between a laser frequency of the coherent optical transmitter and a laser frequency of the coherent optical receiver satisfies a threshold so as to enable the extracting.

2. The device of claim 1, wherein the threshold is defined based on a sampling frequency of the coherent optical receiver and a length of a memory associated with the coherent optical receiver.

3. The device of claim 1, wherein the Tx pattern has a duration that covers a desired frequency range.

4. The device of claim 1, wherein the Tx pattern is a periodic pattern or a pseudo-random pattern.

5. The device of claim 1, wherein the extracting comprises
extracting the transfer function of the coherent optical receiver and the one or more impairments associated with the coherent optical receiver by
circularly shifting the Tx pattern to align the Tx pattern with the Rx pattern,
determining a sampling clock offset and laser phase noise based on cross-correlation of the Tx pattern and the Rx pattern in a frequency domain,
modulating the Tx pattern with the sampling clock offset and the laser phase noise, resulting in a modulated Tx pattern, and
based on the modulated Tx pattern and the Rx pattern, learning a first matrix of finite impulse response (FIR) taps that corresponds to the transfer function of the coherent optical receiver, wherein different arrangements of elements in the first matrix correspond to different Rx linear impairments.

6. The device of claim 5, wherein the extracting further comprises
extracting the transfer function of the coherent optical transmitter and the one or more impairments associated with the coherent optical transmitter by
backpropagating the Rx pattern via inversion of a linear impact of the first matrix and demodulation of the modulated Tx pattern, resulting in a backpropagated Rx pattern, and
based on the backpropagated Rx pattern and the Tx pattern, learning a second matrix of FIR taps that corresponds to the transfer function of the coherent optical transmitter, wherein different arrangements of elements in the second matrix correspond to different linear impairments.

7. The device of claim 1, wherein the device is an external computing device that is separate from the coherent optical transmitter and the coherent optical receiver.

8. The device of claim 1, wherein the device is, or is incorporated in, a coherent optical modem that includes the one or more of the coherent optical transmitter and the coherent optical receiver.

9. The device of claim 1, wherein the coherent optical transmitter and the coherent optical receiver are both included in a coherent optical modem, and wherein the offset is provided by an acousto-optical modulator (AOM).

10. The device of claim 1, wherein the coherent optical transmitter and the coherent optical receiver are included in different coherent optical modems.

11. The device of claim 1, wherein the coherent optical transmitter is calibrated and serves as a reference to facilitate the extracting of the transfer function of the coherent optical receiver and the one or more impairments associated with the coherent optical receiver.

12. The device of claim 1, wherein the operations further comprise at least one of
pre-processing a Tx waveform based on an extraction of the one or more impairments associated with the coherent optical transmitter to facilitate a determination of one or more residual calibration errors relating to residual Tx linear impairments, wherein the residual Tx linear impairments include in-phase (I)/quadrature phase (Q) tributary mismatch, quadrature error (QE), residual crosstalk between I/Q tributaries, or a combination thereof; or
post-processing an Rx waveform based on an extraction of the one or more impairments associated with the coherent optical receiver to facilitate a determination of one or more residual calibration errors relating to residual Rx linear impairments, wherein the residual Rx linear impairments include I/Q tributary mismatch, QE, residual crosstalk between I/Q tributaries, or a combination thereof.

13. The device of claim 1, wherein the extracting involves measurement of
a nonlinear response of one or more components in an opto-electrical (OE) chain of the coherent optical receiver;
a nonlinear response of one or more components in an electro-optic (EO) chain of the coherent optical transmitter;
in-phase (I)/quadrature phase (Q) linear response mismatches in the coherent optical receiver;
I/Q linear response mismatches in the coherent optical transmitter;
crosstalk between I/Q tributaries in the coherent optical receiver;
crosstalk between I/Q tributaries in the coherent optical transmitter;
quadrature error (QE) between the I/Q tributaries in the coherent optical receiver;
QE between the I/Q tributaries in the coherent optical transmitter; or
a combination thereof.

14. The device of claim 13, wherein the one or more components in the OE chain comprise an analog-to-digital-converter (ADC) and a transimpedance amplifier (TIA), and wherein the one or more components in the EO chain comprise a digital-to-analog converter (DAC) and a driver or amplifier.

15. The device of claim 13, wherein the I/Q linear response mismatches in the coherent optical receiver and the coherent optical transmitter comprise I/Q differential delay.

16. The device of claim 13, wherein the I/Q tributaries in the coherent optical receiver and the coherent optical transmitter comprise an X polarization in-phase component (XI), an X polarization quadrature phase component (XQ), a Y polarization in-phase component (YI), and a Y polarization quadrature phase component (YQ).

17. A non-transitory machine-readable medium, comprising executable instructions that, when executed by a processing system including a processor, facilitate performance of operations, the operations comprising:
based on a transmission of a transmit (Tx) pattern from a coherent optical transmitter and a receipt of a corresponding receive (Rx) pattern at a coherent optical receiver, extracting a transfer function of the coherent optical transmitter, a transfer function of the coherent optical receiver, one or more impairments associated with the coherent optical transmitter, one or more impairments associated with the coherent optical receiver, or a combination thereof to facilitate calibration or impairment characterization of one or more of the coherent optical transmitter and the coherent optical receiver,
wherein an offset between a laser frequency of the coherent optical transmitter and a laser frequency of the coherent optical receiver satisfies a threshold so as to enable the extracting.

18. The non-transitory machine-readable medium of claim 17, wherein the threshold is defined based on a sampling frequency of the coherent optical receiver and a length of a memory associated with the coherent optical receiver.

19. A method, comprising:
based on a transmission of a transmit (Tx) pattern from a coherent optical transmitter and a receipt of a corresponding receiver (Rx) pattern at a coherent optical receiver, extracting, by a processing system including a processor, a transfer function of the coherent optical transmitter, a transfer function of the coherent optical receiver, one or more impairments associated with the coherent optical transmitter, one or more impairments associated with the coherent optical receiver, or a combination thereof to facilitate calibration or impairment characterization of one or more of the coherent optical transmitter and the coherent optical receiver,
wherein an offset between a laser frequency of the coherent optical transmitter and a laser frequency of the coherent optical receiver satisfies a threshold so as to enable the extracting.

20. The method of claim 19, wherein the threshold is defined based on a sampling frequency of the coherent optical receiver and a length of a memory associated with the coherent optical receiver.
